(19) United States
(12) Patent Application Publication
(10) Pub. No.: US 2010/0053479 A1
(43) Pub. Date: Mar. 4, 2010

(54) LASER TELEVISION CABINET

(76) Inventor: Hiromi Kamel, Irvine, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/544,858

(22) Filed: Aug. 20, 2009

Related U.S. Application Data
(60) Provisional application No. 61/093,315, filed on Aug. 30, 2008.

(51) Int. Cl. H04N 5/64

(52) U.S. Cl. 348/789; 348/E05.128

(57) ABSTRACT

A laser light source based television cabinet that facilitates housing a television laser light source and chassis comprising logic circuits and other electronic components exteriorly to the interior of the television cabinet to avoid exposing the optics to dust and dirt and the technician to possible direct contact with light from the laser light source.

### CROSS-REFERENCE TO RELATED APPLICATION

This application claims the benefit of provisional application Ser. No. 61/093315 filed Aug. 30, 2008, which is fully incorporated herein by reference.

### FIELD

The embodiments described herein relate generally to television and particularly laser light source based televisions, and, more particularly, to a novel television cabinet that facilitates safe and clean assembly, operation and maintenance.

### BACKGROUND INFORMATION

Conventional projection televisions typically include an enclosure housing a display screen, a light source, an image engine, optics including mirrors, and a chassis upon which logic circuits or boards and other electronic components are mounted. In order to repair or conduct maintenance on the chassis components or the light source, access to the interior of the enclosure is necessary by either removing or opening the enclosure. However, opening or removing the enclosure to access its interior to access the light source and/or chassis components, exposes the optics to dirt and dust which can damage and/or hinder the performance of the optics. Where the light source for the television is a laser device or system, opening the enclosure and accessing its interior or removing the enclosure can result in the technician or user being hit by laser light directly in the eye or on the skin, which could result in severe damage to the eye and/or skin.

Thus, a television cabinet that facilitates safe and clean assembly, operation and maintenance is desirable.

### SUMMARY

The embodiments provided herein are directed to a television cabinet that facilitates safe and clean assembly, operation and maintenance. In one embodiment, a television includes a video display screen mounted on an enclosure. The enclosure houses the image engine and optics including mirrors and lenses optically coupled to the display screen. An access cavity providing access to the interior of the enclosure and, thus, access to the image engine and optics is formed toward the bottom of the enclosure and is closable with an optics enclosure cover. The enclosure further includes a mounting region or recess on the back side of the enclosure and exterior to the interior of the enclosure. A laser light source, which is optically coupled to the image engine and optics via fiber optic cables or other wave guides, and a chassis comprising the television logic circuits and components, as well as other electrical and electronic components typically housed within the enclosure, are mounted to the enclosure at the mount region or in the mounting recess. A light source enclosure cover, which is separate from the optics enclosure cover, is used to cover the light source, chassis and chassis components.

Other objects, systems, methods, features, and advantages of the invention will be or will become apparent to one with skill in the art upon examination of the following figures and detailed description. It is intended that all such additional systems, methods, features and advantages be included within this description, be within the scope of this invention, and be protected by the accompanying claims. It will be understood that the particular methods and apparatus are shown by way of illustration only and not as limitations. As will be understood by those skilled in the art, the principles and features explained herein may be employed in various and numerous embodiments.

### BRIEF DESCRIPTION OF THE FIGURES

The details of the example embodiments, including fabrication, structure and operation, may be gleaned in part by study of the accompanying figures, in which like reference numerals refer to like parts. The components in the figures are not necessarily to scale, emphasis instead being placed upon illustrating the principles of the example embodiments. Moreover, all illustrations are intended to convey concepts, where relative sizes, shapes and other detailed attributes may be illustrated schematically rather than literally or precisely.

FIG. 1 is a side view schematic of a conventional projection television (PTV).

FIG. 2 is a side view schematic of a laser PTV with a preferred cabinet.

FIG. 3 is a perspective view schematic of a laser PTV with a preferred cabinet.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

Each of the additional features and teachings disclosed below can be utilized separately or in conjunction with other features and teachings to produce a television cabinet that facilitates housing a television laser light source and chassis comprising logic circuits and other electronic components exteriorly to the interior of the television enclosure. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

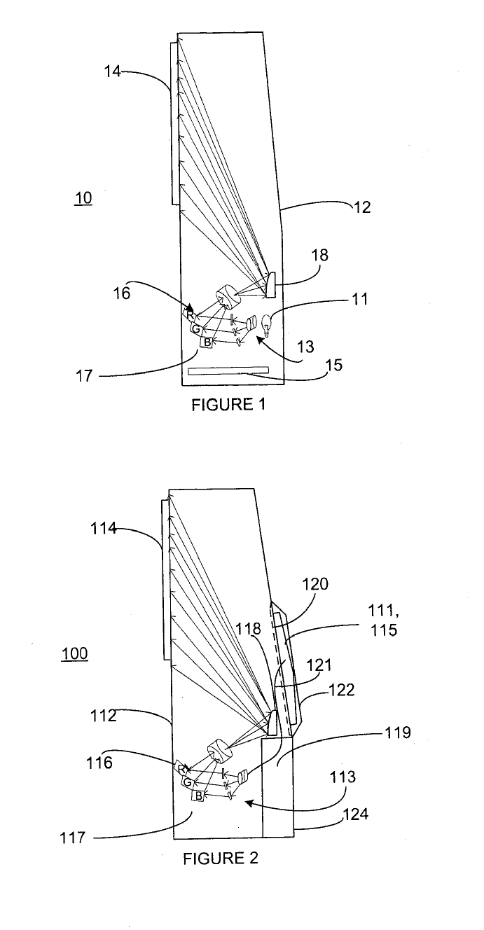

Turning in detail to the figures, FIG. 1 depicts a schematic of a conventional projection television (PTV) 10. The PTV 10 comprises a cabinet or enclosure 12, an image projection engine or system 13, e.g., DLP, LCD or LCOS based projection engine or the like, optics such as mirrors 16 coupled to the image engine 13, a light source 11 coupled to the image engine 13, a projection screen assembly 14 attached to the front of the cabinet 12, and a mirror 18 mounted in the interior 17 of the cabinet 12 and optically coupled to the projection screen assembly 14 and the image projection engine 13 and optics 16. Also mounted in the interior 17 of the cabinet 12 is a chassis 15 comprising logic circuits and other electronic components.

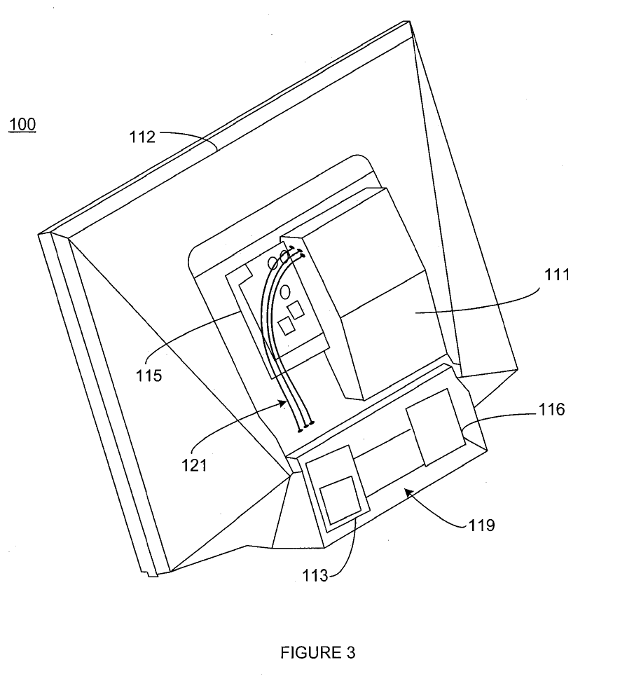

As depicted in FIGS. 2 and 3, a preferred embodiment of a laser based PTV 100 preferably includes a chassis 115 and laser light source 111 mounted on the rear exterior of an enclosure or cabinet 112. Mounted or housed within the interior 117 of the enclosure 112 are an image projection engine or system 113, such as, e.g., a DLP, LCD or LCOS based projection engine or the like, optics such as mirrors 116 coupled to the image engine 113, and a mirror 118 mounted in the interior 117 of the cabinet 112 and optically coupled to a projection screen assembly 114 mounted on the front of the cabinet 112 and the image projection engine 113 and optics 116.

The enclosure 112 preferably includes a mounting region or recess 120 formed in its back side. The chassis 115 and laser light source 111 are exteriorly mounted to the enclosure 112 on or in the mounting region or recess 120 and protected with a removable cover 122. The light source 111 is optically coupled to the image engine 113 and optics 116 via fiber optic cables or other wave guides 121 sealingly extending through the wall of the enclosure 112.

The enclosure 112 further includes an access cavity 119 formed therein toward the bottom of the enclosure 112 and providing access to the interior 117 of the enclosure 112 and the image engine 113 and optics 116. The access cavity 119 is closed with a removable cover 124 that is separate from the light source and chassis cover 122.

If any components on the chassis 115 or the light 111 need repair or maintenance, they are advantageously accessed without entering the interior 117 of the enclosure 112 and exposing the optics 116 to dirt and dust and the technician to possible direct exposure to laser light from the laser light source by removing the light source and chassis cover 122.

In the foregoing specification, specific example embodiments have been described. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. A television comprising
an enclosure,
a screen coupled to the enclosure,
a mirror mounted in the interior of the enclosure and coupled to the screen,
an exterior recess formed in a back wall of the enclosure,
an electronic component chassis mounted in the recess of the enclosure,
a laser light source mounted in the recess of the enclosure,
image projection engine and optics mounted in the interior of the enclosure and operably coupled to the mirror and the laser light source, and
a cover mountable to the enclosure to cover the recess, chassis and laser light source.

2. The television of claim 1 further comprising fiber optic cables extending from the laser light source through the wall of the enclosure to the image projection engine and optics.

3. The television of claim 1 wherein the enclosure further comprises an access cavity formed therein toward the bottom of the enclosure providing access to the interior of the enclosure and the image engine and optics.

4. The television of claim 3 further comprising a removable cover that is separate from the light source and chassis cover and couplable to the enclosure to cover the access cavity.

5. A television comprising
an enclosure,
a screen coupled to the enclosure,
an exterior recess formed in a back wall of the enclosure,
an electronic component chassis mounted in the recess of the enclosure,
image engine mounted in the interior of the enclosure and coupled to the screen, and
a cover mountable to the enclosure to cover the recess and chassis.

6. The television of claim 5, further comprising a mirror mounted in the interior of the enclosure and coupled to the screen and image engine.

7. The television of claim 5, further comprising a laser light source mounted in the recess of the enclosure coupled to the image engine.

8. The television of claim 6, wherein the image engine is a image projection system operably coupled to the mirror.

9. The television of claim 8, further comprising optics mounted in the interior of the enclosure and operably coupled to the mirror.

10. The television of claim 7 further comprising fiber optic cables extending from the laser light source through the wall of the enclosure to the image engine.

11. The television of claim 5 wherein the enclosure further comprises an access cavity formed therein toward the bottom of the enclosure providing access to the interior of the enclosure and the image engine.

12. The television of claim 11 further comprising a removable cover that is separate from the recess and chassis cover and couplable to the enclosure to cover the access cavity.
